(19) United States
(12) Patent Application Publication
(10) Pub. No.: US 2010/0114934 A1
(43) Pub. Date: May 6, 2010

(54) METHOD AND ARRANGEMENT IN A COMMUNICATION DEVICE

(75) Inventor: Viktor MARTENSSON, Loberod (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/253,299

(22) Filed: Oct. 17, 2008

(51) Int. Cl. G06F 17/30

(52) U.S. Cl. 707/769; 707/E17.032; 707/E17.135

(57) ABSTRACT

A method in a communication device, of retrieving a playlist of the most played music within a certain user defined geographical area is provided. The playlist may be retrieved from a database. The communication device and the database may be adapted to communicate with each other. The method may include sending a request for retrieving a playlist. The request may be sent to the database. Also, the method may include receiving the requested playlist from the database.

### TECHNICAL FIELD

The present invention generally relates to a method and an arrangement in a communication device, a database, and computer programs and, more particularly, to a mechanism for retrieving media-related data associated with geographical positions.

### BACKGROUND

Electronic devices, e.g., portable electronic devices, such as cordless and cellular telephones, pagers, wireless modems, wireless email devices, and personal digital assistants (PDAs) with communication functions, and other portable electronic devices, are becoming increasingly commonplace. Some portable electronic devices may be configured to communicate with other devices over a wireless communications network. Users of portable electronic devices typically take the devices with them just about everywhere they go, which allows the users to, for example, place phone calls, take pictures, listen to music, send/receive text messages, consult calendars, watch videos, send/receive email, and/or access the Internet and the information available thereon, using the portable electronic device.

It may frequently occur that an individual travelling abroad (or to an otherwise less familiar location) would like to be informed of and/or listen to music that is currently popular in that particular area. As an example, an individual travelling to New York, N.Y. may want to learn what music in that locale is the most popular at present, in order to be auditively acclimatized and culturally aware. It may further be a problem, for example, for a music group manager/promoter to plan a concert tour whereby as many fans as possible have an opportunity to experience the concert, or to promote their most recently released music, for example, in the form of a new record in an optimized way.

No convenient method exists for retrieving such information associated with a particular, arbitrary geographical location. One way of achieving the desired information may be to ask people living or presently available at the particular area in question, to list their favorite music, i.e., to perform a local poll. A possible solution may be to approach some locals in an attempt to perform the poll. However, the successfulness of achieving the requested information is highly dependent on the time and availability of the persons approached. The described procedure also involves asking people on an individual basis, meaning that a number of persons could not be reached all at once in a convenient way. Thus, besides occupying the individual's own time, he/she also risk consuming others' time by making such inquiries.

Further, such questioning may also be perceived as unsolicited harassment by a sensitive person, thus further reducing the willingness of cooperation of that person, which is a sine qua non for a successful inquiry. The socially tactful person is likely to be very reluctant to use such an intrusive interrogation method towards strangers, which method may be perceived as very annoying, disturbing, irritating, aggravating, and even pestering by the recipient.

It may be a further problem to get reliable input from such polling. Many people may not answer to such a poll at all, due to high workload, general stress, trying relationships, and preoccupation with family situations, etc. Others may be reluctant to answer such poll due to, e.g., an individual estrangement from the local community and other individuals in general as a reaction to the atomism of modern society. Yet a problem may be that some people may lie and state other tunes as his/her favorite music than is the case, as he/she may be afraid of being regarded as being out of fashion, odd, unsophisticated, tone deaf, tasteless, vulgar, etc.

It is further a problem for the person residing in an unknown place to find out local hit list music, in particular when not conversant in the local language.

Studying sales statistics over sold music records may be a possibility, however, due to the widespread use of illegal copying and/or downloading, such sale statistics may not be reflective of actual circulation data.

Reading music industry literature in local magazines and/or news papers may provide an indication of what music is popular in a locale, but again, the individual may lack the necessary linguistic skills. In case the local language is using an alphabet unfamiliar to the individual seeking the information, even the most simple information search imaginable may be impossible to perform as music artists' names may not be spelled in a recognizable way.

Also, such research is likely to be perceived as tedious and time-consuming to the average person.

In addition, as competition increases among manufacturers of communication devices, a marketing need exists for new functions and features.

### SUMMARY

Embodiments of the present invention provide a mechanism for facilitating the retrieval of media-related data associated with geographic locations.

Embodiments of the present invention relate to a method in a communication device of retrieving media-related data from a database. The communication device and the database may communicate with each other. The database may include media-related events associated with geographical positions. The method may include determining a geographical area, for which media-related data is to be retrieved. The method may also include sending a request to the database, requesting media-related data associated with the determined geographic area. The method may include receiving, from the database, the requested media-related data associated with the determined geographic area. The method may include presenting the received media-related data to a user if the communication device.

Embodiments of the present invention provide a computer-readable storage medium encoded with a computer program for retrieving media-related data from a database. The database may communicate with a communication device. The database may include media-related events associated with geographical positions. The computer program may include computer program code configured to make a processor included within the communication device determine a geographical area, for which media-related data is to be retrieved. The computer program code may be configured to cause the processor to send a request to the database, requesting media-related data associated with the determined geographical area. The computer program code may be configured to cause the processor to receive the requested media-related data associated with the determined geographical area, from the database, when the computer program code is executed on the processor.

Embodiments of the present invention provide an arrangement in a communication device, which is configured to retrieve media-related data from a database. The communication device and the database may communicate with each other. The database may include media-related events associated with geographical positions. The arrangement may include an input unit. The input unit may be adapted to input a determination of a geographical area, for which media-related data is to be retrieved. The arrangement may include a sending unit. The sending unit may be adapted to send a request to the database, requesting media-related data associated with the determined geographical area. The arrangement may include a receiving unit. The receiving unit may be adapted to receive, from the database, the requested media-related data associated with the determined geographical area.

Embodiments of the present invention provide a method in a database, of providing media-related data to a communication device. The communication device and the database may communicate with each other. The database may include media-related events associated with a geographical position. The method may include receiving a request from the communication device to provide media-related data to the communication device. The request may include a representation of a geographical area determined by the communication device and a trigger to search through the database, for the requested media-related data associated with the received geographical area. The method may include detecting the trigger and the requested media-related data. The method may include searching in the database for the requested media-related data. The method may include extracting the requested media-related data from the database. The method may include providing the requested media-related data to the communication device.

Embodiments of the present invention provide a computer-readable storage medium encoded with a computer program for providing media-related data from a database to a communication device. The communication device and the database may communicate with each other. The database may include media-related events associated with a geographical position. The computer program may include computer program code configured to make a processor, included within the database, perform the step of receiving a request from the communication device to provide media-related data to the communication device. The request may include a representation of a geographical area determined by the communication device and a trigger to search through the database, for the requested media-related data associated with the received geographical area. The computer program code may be configured to cause the processor to perform the step of detecting the trigger and the requested media-related data. The computer program code may be configured to cause the processor to perform the step of searching in the database for the requested media-related data. The computer program code may be configured to cause the processor to perform the step of extracting the requested media-related data from the database. In addition, the computer program code may be configured to cause the processor perform the step of providing the requested media-related data to the communication device when the computer program code is loaded into the processor.

Embodiments of the present invention provide an arrangement in a database, adapted to provide media-related data to a communication device. The database and the communication device may communicate with each other. The database may include media-related events associated with a geographical position. The arrangement may include a receiving unit. The receiving unit may be adapted to receive a request from the communication device to provide media-related data to the communication device. The request may include a representation of a geographical area determined by the communication device and a trigger to search through the database for the requested media-related data associated with the received geographical area. The arrangement may include a detecting unit. The detecting unit may be adapted to detect the trigger and the requested media-related data. The arrangement may include a searching unit. The searching unit may be adapted to search in the database for the requested media-related data when the trigger is detected in the request. The arrangement may include an extracting unit. The extracting unit may be adapted to extract the requested media-related data from the database. The arrangement may include a providing unit. The providing unit may be adapted to send the requested media-related data to the communication device.

An advantage of the present methods and devices is that statistical information concerning media usage within a user-defined geographical area may be retrieved in a convenient way, with a minimum of effort involved both at the sender side and at the recipient side. Thus, an improved mechanism for facilitating the retrieval of media-related data associated with geographical positions is provided.

### BRIEF DESCRIPTION OF THE DRAWINGS

The present invention will now be described more in detail in relation to the enclosed drawings, in which:

FIG. 1 is a schematic block diagram illustrating a wireless communication network according to an embodiment of the present solution;

FIG. 2 is a schematic block diagram illustrating exemplary components of a base station according to some embodiments;

FIG. 3A is a schematic block diagram illustrating exemplary components of a communication device according to some embodiments;

FIG. 3B is a schematic block diagram illustrating a communication device according to some embodiments where the communication device is embodied as a cellular telephone;

FIG. 4A is a combined signalling and flowchart illustrating signal transmission according to some embodiments;

FIG. 4B is a combined signalling and flowchart illustrating signal transmission according to some embodiments;

FIG. 5 is a flow chart depicting a method in a communication device for retrieving music related data from a database;

FIG. 6 is a block diagram depicting an arrangement in a communication device;

FIG. 7 is a flow chart depicting a method in a database for providing media-related data to a communication device; and

FIG. 8 is a block diagram depicting an arrangement in a database.

### DETAILED DESCRIPTION

Embodiments of the invention include a method and an arrangement in a communication device, a method, and an arrangement in a database and computer programs which may be put into practice in the implementations described below. The invention may, however, be embodied in many different forms and should not be construed as limited to the embodiments set forth herein; rather, these embodiments are provided so that this disclosure will be thorough and complete, and will fully convey the scope of the invention to those skilled in the art. It should be understood that there is no intent to limit the present method and arrangement in a communication device, method and arrangement in a database and computer programs to any of the particular forms disclosed, but on the contrary, the present method and arrangement in a communication device, method and arrangement in a database and computer programs are to cover all modifications, equivalents, and alternatives falling within the scope of the invention as defined by the claims.

Still other advantages and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

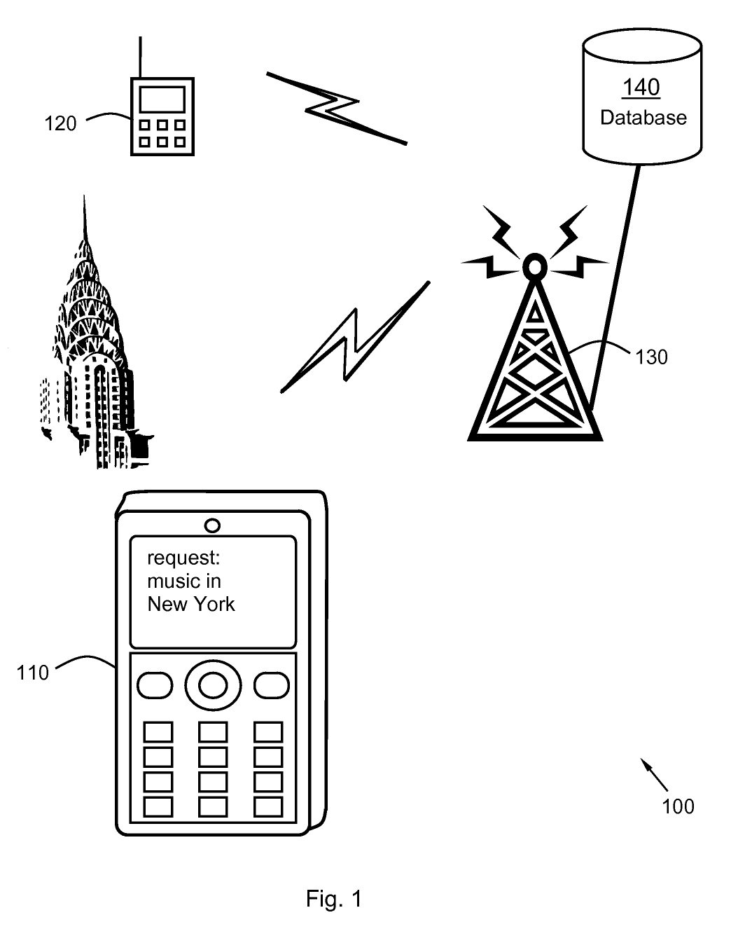

FIG. 1 is a schematic illustration of a communication device 110 in a communication network 100. Communication network 100 may be a wireless or wired communication network 100. When communication network 100 is a wireless network, the communication between communication device 110 and other communication devices, such as a remote communication device 120, may be made over a radio link and may be made using a base station 130 in a cell in wireless communication network 100. Thus communication device 110 may be a wireless device, according to some embodiments, and a wired device, according to other embodiments. Communication network 100A may include database 140. Database 140 may include information data related to geographical positions, as will be explained in detail later.

Although only a single base station transceiver 130 is shown in FIG. 1, it is to be understood that many base station transceivers 130 may be connected through, for example, a mobile switching centre and other devices, to define communication network 100.

In some embodiments, communication device 110 may include a wireless communication terminal, user equipment (UE), a mobile cellular telephone, a personal communications systems (PCS) terminal, a personal digital assistant (PDA), a laptop, a computer (PC), or any other kind of communication device capable of managing communication resources.

In some embodiments, remote communication device 120 may include a wireless communication terminal, UE, a mobile cellular telephone, a PCS terminal, a PDA, a laptop, a computer (PC), or any other kind of communication device capable of managing communication resources.

Communication network 100 may be a wireless communication network, based on technologies such as code division multiple access (CDMA), Wideband Code Division Multiple Access (WCDMA), CDMA 2000, High Speed Downlink Packet Data Access (HSDPA), High Speed Uplink Packet Data Access (HSUPA), High Data Rate (HDR), etc, just to mention some non-limiting examples.

Further, as used herein, communication network 100 may refer to various radio access technologies in the traditional sense, a wireless local area network (LAN) or a wireless personal area network without departing from the teachings of the present invention. These networks may include, for example, radio access technologies, such as Enhanced Data rates for GSM Evolution (EDGE), General Packet Radio Service (GPRS), Global System for Mobile Telecommunications (GSM), High Speed Packet Data Access (HSPA), Universal Mobile Telecommunications System (UMTS) and/or Wireless Local Area Networks (WLAN), such as Wireless Fidelity (WiFi) and Worldwide Interoperability for Microwave Access (WiMAX), Bluetooth®, or according to any other communication technology.

It is to be noted, however, that the invention is not in any way limited to be performed exclusively in a wireless network, but may be performed in a communication network in which some nodes are wirelessly connected and other nodes have a wired connection, or all nodes have a wired connection.

Communication device 110 may be a wireless communication device, such as a mobile cellular telephone and may include, for example, a keypad, a camera module, a speaker, a microphone, a transceiver, and a memory, any of which may communicate with a controller, e.g., a processor and a display. Communication device 110 may include a geographical positioning unit such as a global positioning system (GPS) unit, or similar unit for geographical orientation according to some embodiments.

The geographical positioning unit, such as a GPS unit, may physically reside within communication device 110, or external to communication device 110, but communicating with communication device 110, for example, by using an identifiable short-range radio device, e.g., a Bluetooth® connection, a wired connection, or other suitable means for communication exchange. Thus, according to some embodiments, the GPS unit may be available as an accessory device, external to communication device 110, but connected and/or communicating with communication device 110.

Communication device 110 may, according to some embodiments, use cell ID instead of the GPS unit or as a complement to the GPS unit, in order to determine geographical position. The control unit may be any commercially available or custom microprocessor, e.g., a central processing unit (CPU), a peripheral interface controller (PIC) microcontroller, or any other appropriate device adapted to interpret computer program instructions and process data.

As used herein, “localization” of a geographical position refers to receiving coordinates from, for example, the GPS, and check, for example, against a list to which domain the coordinates belong. The domain may be a city, a portion of a city, a street, a bar, a campus area, a suburban, a country, a continent, etc.

According to some embodiments, “localization” of a geographical position of communication device 110 may be based on the IP address of communication device 110. Such embodiments may be used in particular when communication device 110 is a wired device, for example, a computer with a wired internet connection.

It is to be understood that a domain need not be circular in shape, but may have any regular or irregular shape, for example, a polygon shape. According to some embodiments, the domain may have multiple aspects, for example, in order to answer the question “What is the most popular music in London, Paris, and Berlin right now?”

In the depicted scenario in FIG. 1, a user of communication device 110 is on travel to New York, N.Y. The user of communication device 110 may want to know what music is currently popular in NYC.

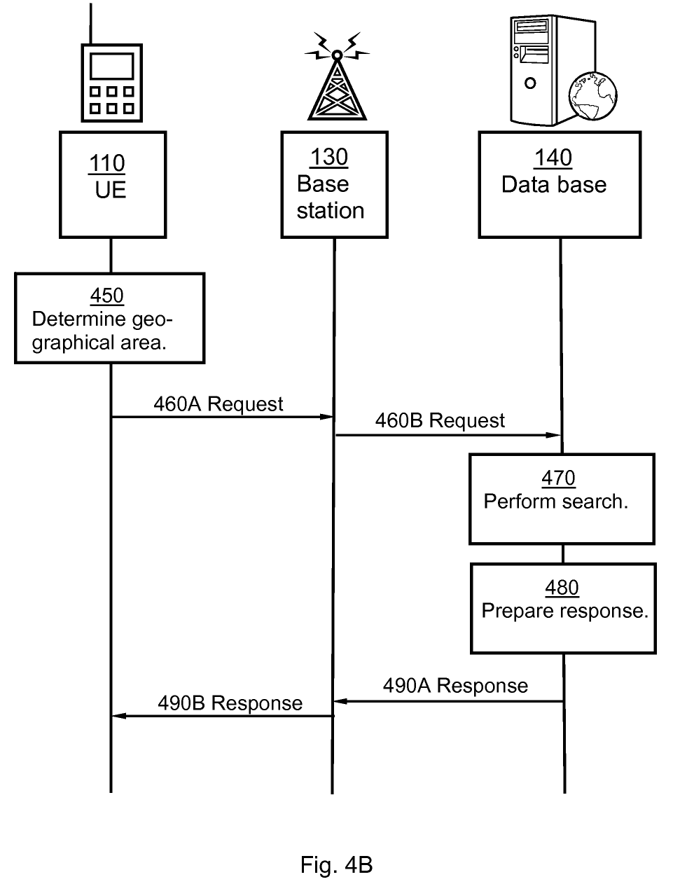

Some embodiments of methods for achieving the desired information from database 140 will be described later in connection with FIG. 4B. Before information could be retrieved from database 140, the information has to be entered into database 140. The latter procedure is further explained and discussed in connection with FIG. 4A.

However, a closer presentation will first be made of communication device 110 and of base station 130.

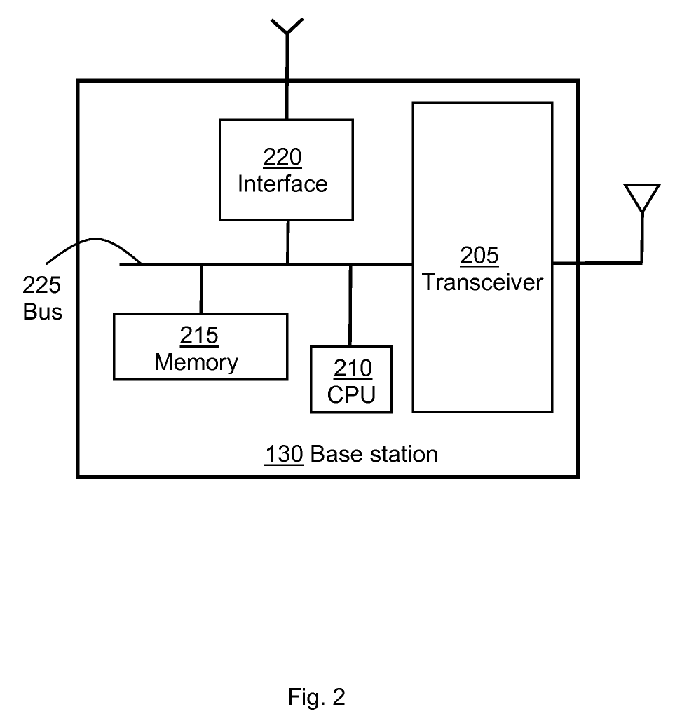

FIG. 2 illustrates one exemplary implementation of base station 130. Base station 130 may include a transceiver 205, a processing unit 210, a memory 215, an interface 220, and a bus 225.

Database 140 may also be similarly configured; however, database 140 may not include, for example, transceiver 205, according to some embodiments.

Base station 130 may, in some embodiments, be represented by a base station, such as an access point, a Node B, an evolved Node B (eNode B), and/or a base transceiver station, Access Point Base Station, base station router, etc., depending, for example, of the radio access technology and terminology used.

Transceiver 205 may include transceiver circuitry for transmitting and/or receiving symbol sequences using radio frequency signals via one or more antennas. The one or more antennas may include a single antenna or an antenna array and may include directional and/or omni-directional antennas. Transceiver 205 may include measurement circuitry that may perform, for example, one or more of various different Evolved Universal Terrestrial Radio Access Network (E-UTRAN) radio fingerprint measurements, for example, such as measuring the Evolved Universal Terrestrial Radio Access (E-UTRA) Reference Signal (DL RS) transmit power at base station 130.

Processing unit 210 may include a CPU, a processor, a microprocessor, and/or processing logic that may interpret and execute instructions. Processing unit 210 may perform all data processing functions for inputting, outputting, and processing of data including data buffering and device control functions, such as call processing control, user interface control, or the like. Thus, processing unit 210 may perform all data processing functions for base station 130.

Memory 215 may provide permanent, semi-permanent, or temporary working storage of data and instructions for use by processing unit 210 in performing device processing functions. Memory 215 may be a primary storage memory unit, such as a processor register, a cache memory, a random access memory (RAM), or the like. Memory unit 215 may include a secondary memory unit such as a read only memory (ROM), electrically erasable programmable read-only memory (EEPROM), programmable read-only memory (PROM), erasable programmable read-only memory (EPROM), or a hard disk drive. Memory unit 215 may include an off-line storage memory unit, a flash memory, a USB memory or a memory card. Memory unit 215 may include a network-attached storage (NAS) or in fact any other appropriate medium such as and/or optical recording medium and its corresponding drive, or any other disk, tape or media that can hold machine readable data.

Interface 220 may include circuitry for interfacing with a link that connects, for example, to a gateway. Bus 225 may interconnect the various components of base station 130 to permit the components to communicate with one another.

The configuration of components of base station 130 illustrated in FIG. 2 is for illustrative purposes only. Other configurations including more, fewer, or a different arrangement of components may be implemented.

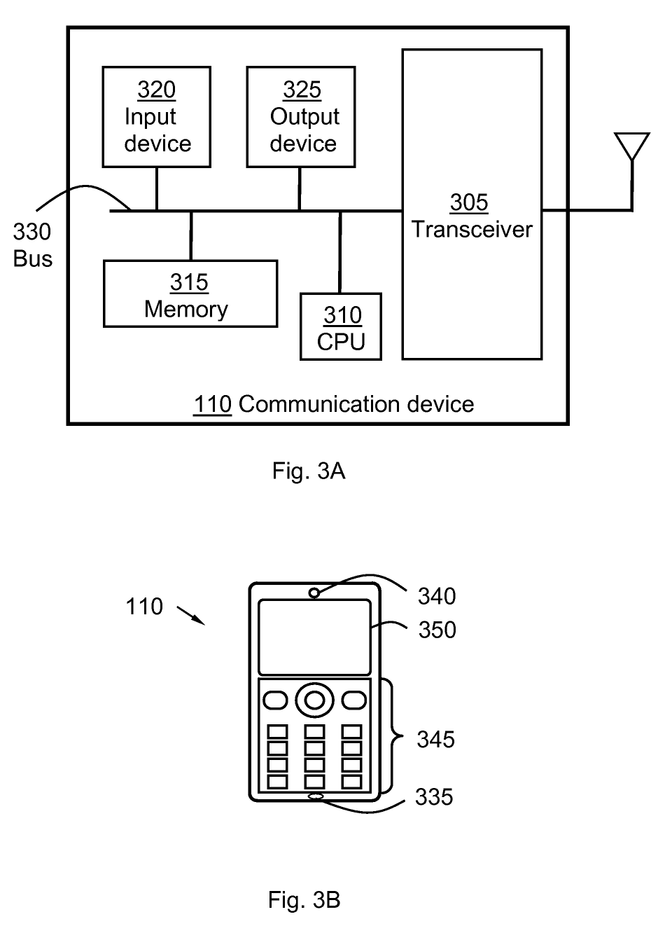

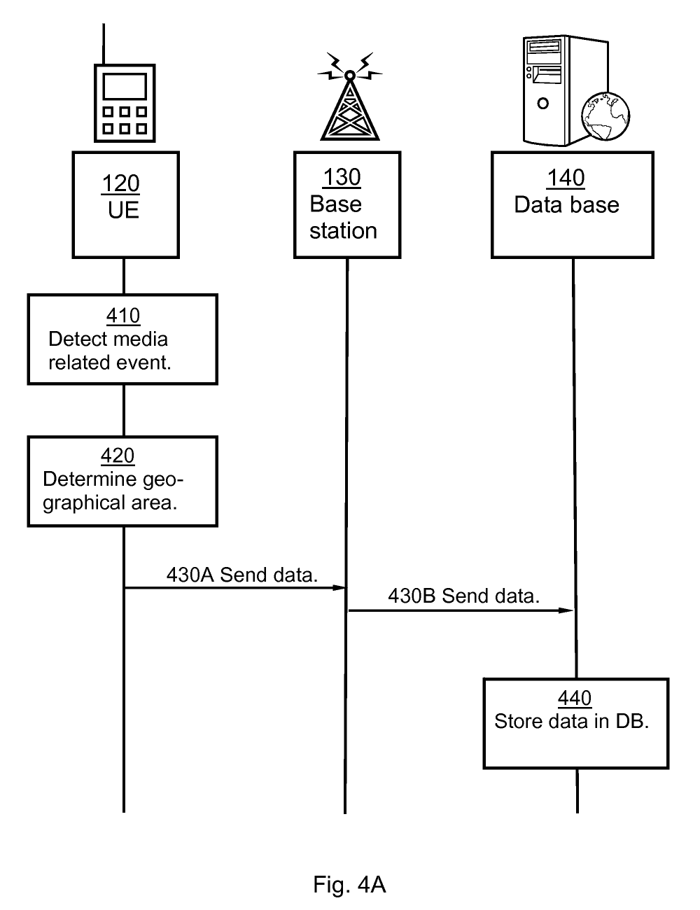

FIG. 3A illustrates communication device 110 consistent with an exemplary embodiment in which communication device 110 is a wireless device 110. Other, more or less remote communication devices 120 may be similarly configured. Wireless communication device 110 may include, for example, a transceiver 305, a processing unit 310, a memory 315, an input device 320, an output device 325, and a bus 330.

Transceiver 305 may include transceiver circuitry for transmitting and/or receiving symbol sequences using radio frequency signals via one or more antennas.

Processing unit 310 may include a CPU, processor, microprocessor, or processing logic that may interpret and execute instructions. Processing unit 310 may perform all data processing functions for inputting, outputting, and processing of data including data buffering and device control functions, such as call processing control, user interface control, or the like.

Memory 315 may provide permanent, semi-permanent, or temporary working storage of data and instructions for use by processing unit 310 in performing device processing functions. Memory 315 may include ROM, RAM, large-capacity storage devices, such as a magnetic and/or optical recording medium and its corresponding drive, and/or other types of memory devices. Input device 320 may include mechanisms for entry of data into wireless communication device 110. As a non-limiting example only, input device 320 may include a key pad. The key pad may permit manual user entry of data into wireless communication device 110. Input device 320 may, according to some embodiments, include a microphone. The microphone may in turn include mechanisms for converting auditory input into electrical signals. According to some embodiments, input device 320 may include a touch screen functionality.

Output device 325 may include mechanisms for outputting data in audio, video, and/or hard copy format. For example, output device 325 may include a speaker that includes mechanisms for converting electrical signals into auditory output. Output device 325 may include a display unit that displays output data to the user. For example, the display unit may provide a graphical user interface that displays output data to the user. Bus 330 may interconnect the various internal components of wireless communication device 110 to permit the components to communicate with one another.

The configuration of components of wireless communication device 110 illustrated in FIG. 3A is for illustrative purposes only. Other configurations comprising more, fewer, or a different arrangement of components may be implemented. For example, in some implementations, wireless communication device 110 may include a GPS position measuring device, or alternatively be connected, for example, wirelessly, to an attached or associated GPS position measuring device. Further, communication device 110 may be adapted to communicate over a wired connection, such as a wired internet connection.

FIG. 3B illustrates an exemplary implementation of wireless communication device 110 in which wireless communication device 110 is represented by a cellular radiotelephone. As shown in FIG. 3B, wireless communication device 110 may include a microphone 335, for example, of input device 320 for entering audio information into wireless communication device 110, a speaker 340, for example, of output device 325 for providing an audio output from the radiotelephone, a keypad 345, for example, of input device 320 for manual entry of data or selection of telephone functions, and a display 350, for example, of input device 320 or output device 325 that may visually display data to the user and/or which may provide a user interface that the user may use to enter data or to select telephone functions, in conjunction with keypad 345.

Display unit 350 may include a screen display that may provide a user interface, for example, a graphical user interface that can be used by a user for selecting device functions. Display unit 350 may be a touch screen, adapted to register inputs from a user of wireless communication device 110, according to some embodiments.

The screen display of display unit 350 may include any type of visual display, for example, a liquid crystal display (LCD), a plasma screen display, a light-emitting diode (LED) display, a cathode ray tube (CRT) display, an organic light-emitting diode (OLED) display, etc.

Wireless communication device 110 may generate a request by sending a message, for example, a short message service (SMS), multimedia messaging service (MMS), electronic mail (e-mail), a letter, a note, a Bluetooth® broadcast, or similar message. The request may, according to some embodiments, be selected from a list of prewritten requests by the user and may be displayed on the display of wireless communication device 110. The request, according to some embodiments, may include, for example, a tag identifying the request as a request, a tag identifying the type of request, a user determined geographical area, a trigger, which may initiate database 140 to start a search for the requested music related data associated with geographical positions. According to some embodiments, the request may include the geographical position of wireless communication device 110, which thus previously has to be detected, for example, by a GPS functionality associated with wireless communication device 110, or indicated by the user of wireless communication device 110. The request may concern, for example, the most popular music within a defined geographical area, the most popular music of a certain category within a defined geographical area, etc.

FIG. 4A is a combined signalling and flowchart that depicts the transmission of signals between a second communication device 120, database 140 and base station 130, according to some embodiments.

When the user of second communication device 120 execute a media-related event, such as play a music tune, start a game session, or watch a video, information making it possible to identify the media-related event and the geographical position of the second communication device 120 may be sent to database 140. In database 140, the media-related event may be geo-tagged with the geographical position received from second communication device 120. According to some embodiments, other information may be stored in database 140, such as the time and date, the category of media-related event, etc.

It is to be noticed that it is not the media-related information in itself that is geo-tagged, but the media-related event. Thus it is not, for example, a played music tune that is geo-tagged, but the event of replaying the music tune.

410

First, it may be detected that the user of second communication device 120 is executing a media-related event, such as to play a music tune.

420

The geographical position of second communication device 120 may be determined and associated with the previously detected media-related event.

The geographical position of second communication device 120 may be determined in a plurality of ways, for example, by means of a GPS unit of second communication device 120. The position may, according to some embodiments, be approximated by estimating the distance to base station 130. Further approximation may be performed by interpolating signals between neighbouring base stations. Also, according to some embodiments, the geographical position of second communication device 120 may be determined by various techniques, for example, time difference of arrival (TDOA) or enhanced observed time difference (E-OTD). Yet another possibility is to use cell global identity (CGI), which uses the identity that the present cell, or coverage area of base station 130, to locate second communication device 120. CGI may be complemented with the timing advance (TA) information. TA is the measured time between the start of a radio frame and a data burst. However, according to some embodiments, the geographical area may be determined by the user of second communication device 120, for example, by entering a name of the present location such as “New York.” The geographical position of second communication device 120 may be determined based on the IP address of second communication device 120, when second communication device 120 is a wired device.

### 430A, B

The detected media-related event and the associated geographical position of second communication device 120 may be sent to database 140. According to some embodiments, also other related information may be sent to database 140, as previously discussed, such as the time of the performance of the detected media-related event.

440

The sent data including the media-related event and the associated geographical position of second communication device 120 may be received and stored by base station 140.

However, according to some embodiments, music related events and geographical positions may be entered manually directly into database 140. For example, historical information concerning music played in historical times may be entered manually into database 140. Such information may be determined and collected, for example, by studying top lists from different time periods for certain geographical positions.

FIG. 4B is a combined signalling and flowchart that depicts the transmission of signals between communication device 110, database 140, and/or base station 130, according to some embodiments.

Some non-limiting examples of scenarios wherein the present methods and devices 110, 120, 140, may be used will now be discussed. According to a first example, a user, having access to first communication device 110, may want to retrieve music related data associated with certain geographical positions, which geographical positions in this hypothetical example may be determined to correspond, for example, to Manhattan. The “music related data associated with certain geographical positions” may be, for example, a playlist based on what other people have played within the determined geographical area. However, according to some embodiments, the playlist may be a custom designed radio station. Thus, the user can create a radio station that plays music that has been played by others within the defined geographical area. According to some embodiments, the user may predetermine, for example, that an updated top playlist associated with Manhattan is played every time the play button on wireless communication device 110 is indicated, etc. The radio station may be, for example, an FM radio station or an Internet radio station. The user may alternatively create, for example, a music video channel, playing music videos according to the determined top list at the desired geographical position.

By providing geo-tagged music from database 140, a geo-based playlist, concerning a particular determined geographical area or region may be created and sent to communication device 110.

The present methods and arrangements may be used, for example, by a university student who may select a geographical area with the size of the campus, in order to retrieve a playlist based on his/her friends. A new immigrant or tourist may select the new country in order to learn more about the new culture. A further use may be by a homesick expatriate who wants to know what music is popular back home.

According to some embodiments of the invention, certain filters may be applied. A user may determine a geographical area for which the playlist is to be created, but he/she may also determine, for example, the kind of music, such as death metal and the period of time for which the playlist is to be based. Thus, also a historical playlist may be created, and for example, changes in music taste over time within a certain geographical area may be determined.

A historical music playlist may be used, for example, by participants in live historical role play, by history students etc. Some questions that may be answered could hypothetically be, for example, “what music was played in Mesopotamia around 1000 years B.C.?” or “what music was played in Iraq's president palace during the Gulf war?” etc.

It is to be noted that the invention by no means is limited to music play lists. The present methods and arrangements may be used also for collecting statistics concerning games, visited web pages, news pages, etc. Thus, according to some embodiments, the most frequently read news within a certain geographical area may be associated with that area and presented to a user of communication device 110 when entering the geographical area in question and the particular news web page. Thus, a local newspaper may be created with news presented in descending order of presentation frequency for that geographical area.

The user of communication device 110 may, according to some embodiments select what region that is interesting in the query to the database 140. The region selection may also be made automatically by using the location of communication device 110. The location may be detected by means of a GPS functionality within, or attached to, communication device 110. According to yet some embodiments, the user of communication device 110 may use the geographical location of another communication device belonging to another user, for example, a travelling friend, the president of the U.S., or a movie star. According to yet some embodiments, the user of communication device 110 may subscribe to the GPS coordinates of, for example, a movie star and use that location in order to select region of interest.

Another possible use of the present method and arrangement is to associate the download and/or performance of a game, a gaming event, in communication device 110 with a geographical area. For example, trial versions of certain games adapted to be played on communication device 110 may be downloaded for free. Statistics concerning the geographical area of the download/performance of the free trial versions may be used, for example, in order to focus marketing efforts to certain geographical areas and/or to develop versions of the games adapted to the geographical area in question, for example, a local language version, etc.

According to some embodiments, a local version of the telephone catalog may be provided, based on the determined geographical area. The determined geographical area may be the geographical area in which communication device 110 is situated, for example, detected by a GPS functionality.

Yet a possible embodiment of the present method and arrangement is to associate the download and/or performance of an animal cry or animal howl in communication device 110 with a geographical area. For example, a hunter, an ornitholog, a biology teacher, a scout leader, or the like may use the present method and arrangement in order to playback an animal cry or an animal howl of some typical animals within the determined geographical area.

Some general concepts underlying the present methods and arrangements will now be described on basis of FIG. 4B.

The user, having access to communication device 110 may desire a playlist concerning a certain geographical area, which may include music-related data, such as the most frequently played music tunes within the geographical area in question.

450

A geographical area, for which the playlist is to be created, may be determined. According to some embodiments, the geographical area may be determined by the user through various methods. One method may be to place a shape centred over the user's current position. Another method may be to outline the desired region on a map in communication device 110. Yet a method may be to enter the name of the region and/or city and/or neighbourhood in natural language. A further method may be to enter the geographical coordinates corresponding to the current position of communication device 110.

According to some embodiments, the geographical location, for example, a city, such as New York City, that communication device 110 currently is situated in may be determined and a playlist concerning that geographical location may be requested. The current location of communication device 110 may be determined by using, for example, GPS information related to communication device 110.

### 460A

The request may include a tag, or similar means, identifying the request as a request, in order not to confuse it with a normal message, e.g., an SMS. The tag may be, for example, the word “request,” or any other convenient formulation. The request may include the geographical area, geographical coordinates, and/or a representation of geographical coordinates, representing the geographical area, for which a playlist is desired. A parameter determining the length of the requested playlist may be included within the request.

The request may also be created by interacting with an application on communication device 110, specifying parameters. The application on communication device 110 may generate the request which may then be transmitted to the server.

The request may include a trigger which may automatically initiate a search for the requested information data in database 140, when detected. Database 140 may include, for example, music-related data associated with geographical positions. The trigger may be, for example, an indicator, a flag, a word, a sequence of signs, such as two question marks in a row (“??”), or included implicitly within the word “request,” or any other recognizable formulation of information.

It is to be noted that the geographical area and/or geographical information that is detected and placed into the request, may be analyzed and/or categorized and/or interpreted and/or converted before being used in the request. For example, the GPS information that is placed in the request in the above example may not include the latitude/longitude coordinates, but rather an interpretation of what city is situated on those coordinates. This is made in order to enhance readability but also the granularity of the geographical position.

As an example, if the GPS coordinates, N59°19.80012 and E018°4.2, are received, the GPS coordinates may be parsed against a list of localities with their coordinates and the extracted relevant information from such a parsing may be “Stockholm,” “city center,” or “central station,” depending on the dissolution and/or user selection. Thus, the precision of the natural language denomination corresponding to a detected position data ultimately may depend on user selection, according to some embodiments.

However, there may be situations when it is preferred to send the detected relevant information without analysis and/or categorization and/or interpretation and/or conversion.

### 460B

The request may be sent from communication device 110 using an SMS, MMS, an e-mail, or a Bluetooth® broadcast, or in any other convenient way.

Where the request is sent by means of an SMS, MMS, e-mail, or using similar technologies, the request may first be sent to base station 130 and thereafter forwarded to database 140. As database 140 may not necessarily be situated in such a way that it is immediately accessible for base station 130, the request may be forwarded through a plurality of network nodes, according to some embodiments. However, in order not to unnecessarily complicate the presentation of the present methods and arrangements, further optional intermittent nodes have been omitted from the presentation.

According to some embodiments however, communication device 110 may communicate the request directly to database 140, for example, by means of a Bluetooth® connection of a near field communication (NFC) connection or a wired Internet connection.

470

When database 140 receives the request, the request may first be identified as a request. The type of the request, such as which information is requested, may be detected and identified. In this example, the type of request is “contemporary playlist concerning the most popular music on Manhattan, N.Y.” When the trigger has been detected, database 140 initiates a search for the requested music related data in a register and/or memory included within database 140, including music related data associated with a geographical position.

Thus, a search may be performed in a register and/or memory within database 140. A parsing against the content of the register and/or memory may be performed, based on the user determined geographical area. According to some embodiments, the parsing against the content of the register and/or memory may be performed, based on the geographical position of communication device 110.

If a match is found, a compilation may be performed based on the replay frequency of the music-related data in question. A playlist may be compiled, according to the conditions determined by the user in the sent request. Thus, the most-often played music tune within the defined geographical area may be placed first in the playlist, the second most-often played music tune within the defined geographical area is placed second in the playlist, etc. The length of the playlist may be retrieved from the request or predetermined and set, for example, to 5, 10, 20, or 100, just to mention some arbitrarily chosen examples.

### 480A

When a search of database 140 is complete, a response including the requested music related data may be prepared. The response may then be sent to communication device 110 by means of an SMS. The response may be sent, for example, as an MMS, an e-mail or a Bluetooth® broadcast, or in any other convenient way. The playlist may be sent as a playlist file. A playlist file, which may include the requested playlist, is a file that may be interpreted and understood by a media player of communication device 110. Several types of playlists exists and the present solution may be used in association with any convenient type of playlist format, such as .m3u, .pls, .smil, .asx, Kalliope PlayList etc, just to mention some few examples.

### 480B

Depending on the technology used when sending the response including the requested music-related data, and also the distance between database 140 and communication device 110, the propagation route between database 140 and communication device 110 may appear slightly different.

Where the response is sent by means of an SMS, MMS, e-mail, or using similar technologies, the response may first be sent to base station 130 and thereafter forwarded to communication device 110. As communication device 110 need not be situated in such a way that it is immediately accessible for base station 130, the response may have to be further forwarded through a plurality of network nodes, according to some embodiments. However, in order not to unnecessarily complicate the presentation of the present methods and arrangements, further optional intermittent nodes have been omitted from the presentation.

According to some embodiments however, database 140 may communicate the response directly to communication device 110, for example, using a Bluetooth® connection, a wired Internet connection, or another type of connection.

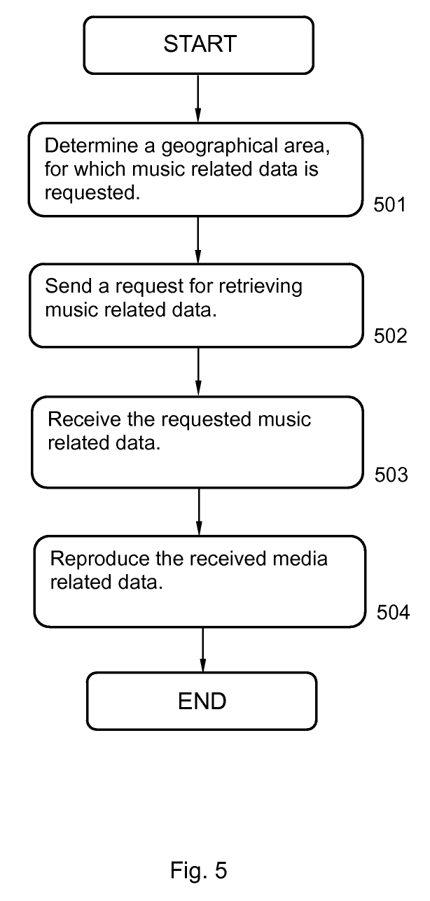

FIG. 5 is a flowchart illustrating a method implemented in communication device 110 for retrieving media-related data from database 140. The media may include, for example, music tunes, audio books, audio guides, spoken words, animal cries, games, animations, news articles, web pages, web services, graphics, maps, movies, film sequences, videos, etc.

As previously mentioned above, communication device 110 and database 140 may be adapted to communicate with each other directly or indirectly. Database 140 may include media-related events associated with geographical positions. The media-related event may be based on the playback and/or performance and/or download of media by a communication device within the defined geographical area.

Communication device 110 may be a wireless communication device 110, such as a mobile cellular telephone, according to some embodiments. Communication device 110 may, according to some embodiments, be a wired device, such as a computer.

The media-related data may include a compiled list of media-related events associated with geographical positions, which may be arranged in descending frequency order, according to some embodiments.

To appropriately retrieve media-related data associated with geographical positions from database 140, the method may include a number of steps 501-504. It is to be noted that the described method steps are optional. The method may include the following steps:

### Step 501

A geographical area, for which media-related data is to be retrieved, is determined. The determination may be performed by the user of the communication device 110. According to some embodiments, the step of determining a geographical area may comprise indicating an area on a map on an optional touch screen interface 350 on the communication device 110. The user may however, according to other embodiments, enter the determined geographical area and/or coordinates representing the determined geographical area and/or a name associated with the determined geographical area manually via the input unit of the communication device 110.

However, according to some embodiments, the step of determining a geographical area may comprise to determine the present geographical position of the communication device 110. According to those optional embodiments, a geographical positioning unit may calculate the position of the communication device 110. The geographical positioning unit may be e.g. a GPS unit, adapted to determine the geographical position of the communication device 110. Further, the geographical positioning unit may be comprised within, attached to or in connection with the communication device 110.

### Step 502

A request for requesting media-related data associated with the determined geographical area may be sent to database 140.

The request may, according to some embodiments, include a trigger to search through database 140 for media-related events associated with the determined geographical area and to compile the requested media-related data.

The requested media-related data may be a playlist of the most played and/or downloaded media, such as music within the determined geographical area, according to some embodiments.

The request for retrieving media-related data may, according to some embodiments, be sent to database 140 using SMS.

Before the request is sent, the request may be composed. The composition of the request may optionally be made automatically, semi-automatically, and/or manually.

The request thus may be composed automatically such that the user of communication device 110 just has to initiate the generation of the request, for example, by activating a key on the keyboard of communication device 110, by pressing a soft key displayed on a touch screen of communication device 110 or, for example, by pressing a combination of keys on the keyboard, just to mention some optional, non-limiting possibilities. Certain information such as a request tag and the optional geographical position of communication device 110 may be incorporated automatically in the request, without further manual input from the user according to some embodiments. A trigger may be incorporated in the request without manual input from the user. According to some other embodiments, the request may be generated manually by the user of communication device 110.

The request may be composed by adding, for example, a request tag and a trigger to the request. Further, information data may be added to the request. The information data may include data from of the group consisting of: geographical position coordinates, music genre, length of the requested playlist, a time span for which the requested playlist is to be based.

### Step 503

The requested media-related data, associated with the determined geographical area is received from database 140.

The requested media-related data may, according to some embodiments, for example, where communication device 110 is a wireless device, be received from database 140 using SMS.

### Step 504

This method step may be performed within some embodiments. The received media-related data may be played back. Thus, a custom designed radio station may be created, based on the current playlist according to predetermined criteria in a certain geographical area.

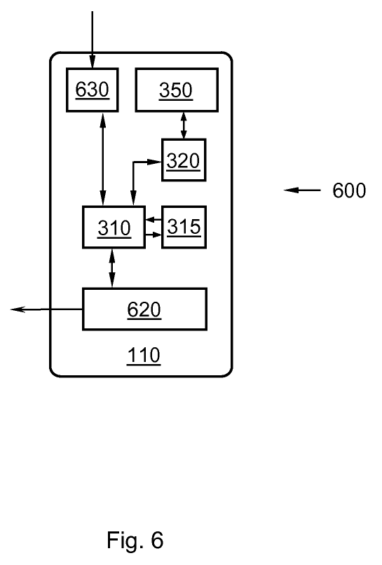

FIG. 6 schematically depicts an embodiment of an arrangement 600 in communication device 110, adapted to perform the above-described method steps 501-504. Arrangement 600 of communication device 110 is thus adapted to retrieve media-related data from database 140. Communication device 110 and database 140 may be adapted to communicate with each other, database 140 may include media-related data associated with geographical positions.

The media may include, for example, music tunes, audio books, audio guides, spoken words, animal cries, games, animations, news articles, web pages, web services, graphics, maps, movies, film sequences, etc.

The media-related event may be based on the playback and/or performance and/or download of a media by communication device 110, 120 within the defined geographical area.

The media-related data may include a compiled list of media-related events associated with geographical positions, which may be arranged in descending frequency order according to some embodiments.

Arrangement 600 of communication device 110 may include, for example, a sending unit 620, a receiving unit 630, and/or memory 315, any of which may communicate with control unit 310, for example, a processor. Communication device 110 may include input unit 320 which in turn may include and/or be connected to touch screen unit 350.

For the sake of clarity and in order not to render unnecessary complications for the reader to understand the functionality and subtle advantages of the present method and arrangement 600 concerning communication device 110, any internal electronics of communication device 110, not necessary for performing the present method according to steps 501-504 has been omitted from FIG. 6.

Arrangement 600 may include input unit 320. Input unit 320 may be adapted to input a determination of a geographical area, for which media-related data is to be retrieved.

Arrangement 600 may include sending unit 620, adapted to send a request to database 140, requesting media-related data associated with the determined geographical area.

Arrangement 600 may include receiving unit 630. Receiving unit 630 may be adapted to receive the requested media-related data associated with the determined geographical area, from database 140.

Further, control unit 310, which may be included within wireless communication device 110, according to some embodiments, may be a CPU, a microprocessor, a PIC microcontroller, and/or any other appropriate device which may be adapted to interpret computer program instructions and processes data.

Memory unit 315, which is comprised within the first communication device 110 according to some embodiments may be a primary storage memory unit such as a processor register, a cache memory, a RAM, or similar. Memory unit 315 may, in some embodiments, be a secondary memory unit such as a ROM, EEPROM, PROM, or EPROM, and/or a hard disk drive. Memory unit 315 may, in some embodiments, be an off-line storage memory unit, a flash memory, a USB memory, and/or a memory card. Memory unit 315 may, in some embodiments, be a NAS or in fact any other appropriate medium such as a disk or a tape that can hold machine readable data.

Control unit 310 may, according to some embodiments, be adapted to generate or at least prepare a request, when the user triggers control unit 310 to generate or at least prepare a request.

Furthermore, according to some embodiments, arrangement 600 in communication device 110 also may include, or be connected to, a geographical positioning unit, such as a GPS unit, or similar unit for geographical orientation and positioning, which also may optionally communicate with control unit 310. According to some embodiments, cell ID may be used instead of the geographical positioning unit or as a complement to the geographical positioning unit.

For example, the geographical positioning unit may be external to communication device 110 without departing from the scope of the present invention. The geographical positioning unit may, according to some embodiments, communicate with communication device 110 via, for example, Bluetooth , a wired connection, and/or any other suitable means for communication and/or exchange of data.

Furthermore, as used herein, “determining a geographical area,” may relate to a geographical area of arbitrary size, such as a city, a potion of a city, a street, a bar, a suburban, a country, a continent, etc.

Communication device 110 may be represented by a wireless communication device, such as a mobile cellular telephone. This may be an advantage in particular when operating in wireless communication network 100.

It is to be noted that above-described units 310-630 included within arrangement 600 in communication device 110 are to be regarded as separate logical entities but not with necessity separate physical entities. Any, some, or all of units 310-630 may be included or co-arranged within the same physical unit. However, in order to facilitate the understanding of the functionality of communication device 110, units 310-630 are illustrated as separate physical units in FIG. 6.

As a non-limiting example only, sending unit 620 and receiving unit 630 may, according to some embodiments, be included within one physical unit, transceiver 305 which may include a transmitter circuit and a receiver circuit, which respectively transmit outgoing radio frequency signals to base station transceiver 205 and receives incoming radio frequency signals, such as voice call and/or data signals, from base station transceiver 205 via an antenna. The antenna may be an embedded antenna, a retractable antenna or any antenna known to those having skill in the art without departing from the scope of the present invention. The radio frequency signals transmitted between communication device 110 and base station 130 may include both traffic and control signals, for example, paging signals/messages for incoming calls, which are used to establish and maintain a voice call communication with another party or to transmit and/or receive data, such as SMS, e-mail, or MMS messages, with other nodes 120 and/or database 140. Processor 310 may support various functions of communication device 110, including functions related to the optional geographical positioning unit, which may be included within first communication device 110, according to some embodiments of the present invention.

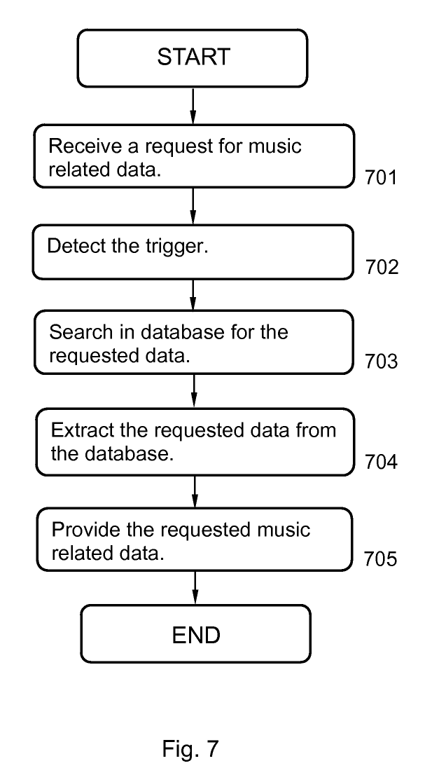

FIG. 7 is a flowchart illustrating a method in database 140 for providing media-related data to communication device 110. Communication device 110 and database 140 may be adapted to communicate with each other. Database 140 may include media-related events associated with a geographical position.

The media may include, for example, music tunes, audio books, audio guides, spoken words, animal cries, games, animations, news articles, web pages, web services, graphics, maps, movies, film sequences, etc.

The media-related event may be based on the playback and/or performance and/or download of a media by communication device 110, 120 within the defined geographical area.

The media-related data may include a compiled list of media-related events associated with geographical positions, which may be arranged in descending frequency order according to some embodiments.

To appropriately provide media-related data to communication device 110, the method may include a number of steps 701-705. It is to be noted that the method steps 701-705 may be performed in any arbitrary chronological order and that some and/or all steps may be performed concurrently and/or in an altered, arbitrarily rearranged, decomposed, and/or reversed chronological order. The method may comprise the following steps:

### Step 701

A request to provide media-related data to communication device 110 may be received from communication device 110. The request may include a representation of a geographical area, determined by communication device 110, and/or a trigger to search database 140, for the requested media-related data associated with the received geographical area. The request may include a tag or reference, identifying the request as a request.

### Step 702

The trigger and the requested media-related data within the request may be detected.

### Step 703

A search within database 140 for the requested media-related data may be performed when the trigger within the received request is detected. Thus, a search in database 140 may be initiated automatically when the trigger is detected.

### Step 704

The requested media-related data may be extracted from database 140. A prerequisite may be that the requested information data is found within database 140. In other cases, an error message or similar signal may be generated and sent to communication device 110.

### Step 705

The requested media-related data is provided to communication device 110. Implementing the present method in database 140, media-related data may be retrieved and provided to communication device 110 in a convenient way, with a minimum of exertion involved.

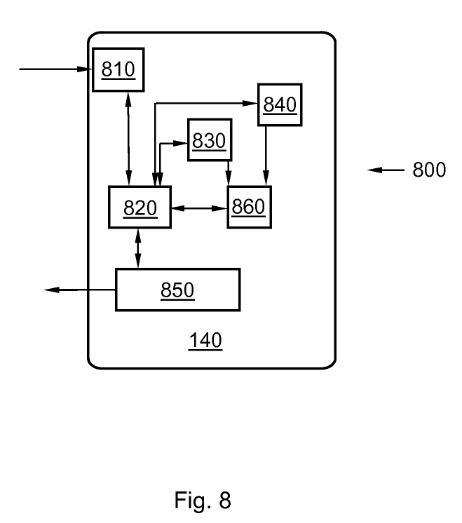

FIG. 8 schematically depicts an embodiment of an arrangement 800 in database 140. Arrangement 800 may be adapted to provide media-related data to communication device 110. Database 140 and communication device 110 may be adapted to communicate with each other. Database 140 may include media-related data associated with a geographical position.

The media may include, for example, music tunes, audio books, audio guides, spoken words, animal cries, games, animations, news articles, web pages, web services, graphics, maps, movies, film sequences, etc.

The media-related event may be based on the playback and/or performance and/or download of a media by communication device 110, 120 within the defined geographical area.

The media-related data may include a compiled list of media-related events associated with geographical positions, which may be arranged in descending frequency order, according to some embodiments.

For the sake of clarity and in order not to render unnecessary complications for the reader to understand the functionality and subtle advantages of the present method and arrangement 800 in database 140, any internal electronics of database 140, not necessary for performing the present method according to steps 701-705 has been omitted from FIG. 8.

Arrangement 800 may include receiving unit 810. Receiving unit 810 may be adapted to receive a request from communication device 110, to provide media-related data to communication device 110. The request may include a representation of a geographical area determined by communication device 110. The request may include a trigger to search database 140 for the requested media-related data associated with the received geographical area.

Arrangement 800 may include a detecting unit 820. Detecting unit 820 may be adapted to detect the trigger and the requested media-related data.

Arrangement 800 may include a searching unit 830. Searching unit 830 may be adapted to search in database 140 for the requested media-related data when the trigger is detected in the request.

Searching unit 830, which may be included within arrangement 800, may be a control unit such as a CPU, a microprocessor, a PIC microcontroller, and/or any other appropriate device adapted to interpret computer program instructions and processes data.

Arrangement 800 may include an extracting unit 840. Extracting unit 840 may be adapted to extract the requested media-related data from database 140.

Arrangement 800 may include a providing unit 850. Providing unit 850 may be adapted to send the requested media-related data to wireless communication device 110.

It is further to be noted that described units 810-850 included within database 140 are to be regarded as separate logical entities but need not separate physical entities. Any, some, or all of the units 810-850 may included and/or co-arranged within the same physical unit. However, in order to facilitate the understanding of the functionality of database 140, comprised units 810-850 are illustrated as separate physical units in FIG. 8.

### EXAMPLES

The present methods for retrieving media data may be implemented through one or more processors 310 in communication device 110, and through one or more processors 820 in database 140, together with computer program code for performing the functions of the methods. The above-mentioned program code may also be provided as a computer program product, for instance in the form of a data carrier carrying computer program code for performing the methods according to the present solution when being loaded into the processor unit. The data carrier may be a CD ROM disc, a memory stick, or any other appropriate medium such as a disk or tape that can hold machine readable data. The computer program code may furthermore be provided as pure program code on a server and downloaded to communication device 110 and database 140 remotely.

Thus a computer-readable storage medium (or device) encoded with a computer program for retrieving media-related data from database 140 to communication device 110 may perform the method steps according to steps 501-504.

Further, a computer-readable medium may be provided, encoded with a computer program for retrieving media-related data from database 140. Database 140 may be adapted to communicate with communication device 110. Database 140 may include media-related data associated with geographical positions. The computer program may include computer program code configured to make processor 310, included within communication device 110, to perform the step of determining a geographical area, for which media-related data is to be retrieved. Also, the computer program code is configured to make the processor 310 perform the step of sending a request to database 140, requesting media-related data associated with the determined geographical area. Further the computer program code may be configured to cause processor 310 to perform the step of receiving the requested media-related data associated with the determined geographical area, from database 140, when the computer program code is executed by processor 310.

A computer-readable medium encoded with a computer program for providing media-related data from database 140 to communication device 110 may perform the method steps according to steps 701-705.

A computer-readable medium may be provided, encoded with a computer program for providing media-related data from database 140 to communication device 110. Communication device 110 and database 140 may be adapted to communicate with each other. Database 140 may include media-related data associated with a geographical position. The computer program may include computer program code configured to cause processor 820, included within database 140, to perform the step of receiving a request from communication device 110 to provide media-related data to communication device 110. The request may include a representation of a geographical area determined by communication device 110 and a trigger to search database 140, for the requested media-related data associated with the received geographical area.

The computer program code may be configured to cause processor 820 to perform the step of detecting the trigger and the requested media-related data. The computer program code may be configured to cause processor 820 to perform the step of searching in database 140 for the requested media-related data. The computer program code may be configured to cause processor 820 to perform the step of extracting the requested media-related data from database 140. The computer program code may be configured to cause processor 820 to perform the step of providing the requested media-related data to communication device 110. The enumerated steps may be performed when the computer program code is executed by processor 820.

As will be appreciated by one of skill in the art, the present invention may be embodied as arrangement 600 in communication device 110, arrangement 800 in database 140, a method in communication device 110, a method in database 140, and/or computer program products. Accordingly, the present invention may take the form of an entirely hardware embodiment, a software embodiment or an embodiment combining software and hardware aspects all generally referred to herein as a “circuit” or “module.” The present invention may take the form of a computer program product on a computer-usable storage medium having computer-usable program code embodied in the medium. Any suitable computer-readable storage device may be used including hard disks, CD-ROMs, optical storage devices, a transmission media such as those supporting the Internet or an intranet, or magnetic storage devices.

Computer program code for carrying out operations of the present methods may be written in any arbitrary programming language such as Java®, Smalltalk, or C++. However, the computer program code for carrying out the steps of the present method may also be written in any conventional procedural programming languages, such as the “C” programming language and/or a lower level assembler language. The program code may execute entirely or partially on communication device 110, as a stand-alone software package, partly on communication device 110 and partly on a remote computing device or entirely on the remote computing device. In the latter scenario, the remote computing device may be connected to communication device 110 via a LAN or a WAN, or the connection may be made to an external computer, for example, via the Internet using an internet service provider (ISP).

The present methods were described in part above with reference to flowchart illustrations and/or block diagrams of communication device 110, database 140, methods, and computer program products according to embodiments of the invention. It will be understood that each block of the various flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The terminology used in the detailed description of the particular exemplary embodiments illustrated in the accompanying drawings is not intended to be limiting of the invention. In the drawings, like numbers refer to like elements.

As used herein, the term “and/or” includes any and all combinations of one or more of the associated listed items.

Further, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation. The common abbreviation “etc.”, which derives from the Latin expression “et cetera” meaning “and other things” or “and so on” may be used herein to indicate that further features, similar to the ones that have just been enumerated, exist, which features however have been omitted herein to not unnecessarily obscure the readers comprehension of the presented subject matter.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The word “media” as used herein is to be understood as meaning not only music but may also comprise games, animations, news articles, web pages, web services, graphics, maps, movies, film sequences, sounds, engravings, audio books, audio guides, spoken words, animal cry, etc., which may be used for presenting a piece of information or a message to a user.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. In a communication device for retrieving media-related data from a database including media-related events associated with geographical positions, a method comprising:
determining a geographical area for which media-related data is to be retrieved;
sending a request to the database, the request requesting media-related data associated with the determined geographical area; and
receiving, from the database, the requested media-related data associated with the determined geographical area.

2. The method of claim 1, where the media-related data comprises a compiled list of media-related that are arranged in descending frequency order.

3. The method of claim 1, where the request comprises a trigger to search the database for media-related events associated with the determined geographical area and to compile the requested media-related data.

4. The method of claim 1, where the requested media-related data is a playlist of the most often played music within the determined geographical area.

5. The method of claim 1, where the communication device is a wireless communication device, and the request for retrieving media-related data is sent to the database via a short messaging service.

6. The method of claim 1, where the determining a geographical area comprises indicating an area on a map on a touch screen interface on the communication device.

7. The method of claim 1, where the determining a geographical area comprises determining the present geographical position of the communication device.

8. The method of claim 1, further comprising:
reproducing the received media-related data.

9. A computer-readable medium encoded with a computer program for retrieving media-related data from a database storing media-related events associated with geographical positions, the computer program to be executed by a processor of a communication device and comprising:
instructions to determine a geographical area corresponding to media-related data to be retrieved;
instructions to send a request to the database requesting media-related data associated with the determined geographical area; and
instructions to receive, from the database, the requested media-related data associated with the determined geographical area.

10. An arrangement in a communication device to retrieve media-related data from a database storing media-related events associated with geographical locations, the arrangement comprising:
an input unit to receive input identifying a geographical area for which media-related data is to be retrieved;
a send unit to send a request to the database for media-related data associated with the determined geographical area; and
a receive unit to receive, from the database, the requested media-related data responsive to the request.

11. The arrangement of claim 10, where the communication device is a wireless communication device.

12. A method for providing media-related data to a communication device from a database storing media-related events associated with a geographical area, the method comprising:
receiving a request from the communication device identifying a geographical area determined by the communication device and a trigger to search the database for the media-related data associated with the identified geographical area;
detecting the trigger and the requested media-related data;
searching the database for the requested media-related data;
obtaining the requested media-related data from the database; and
transmitting the requested media-related data to the communication device.

13. The method of claim 12, where the media-related data comprises a compiled list of media-related events associated with geographical positions being arranged in an order based on frequency.

14. The method of claim 12, where the media-related data is a playlist of the most often played music for the determined geographical area.

15. The method of claim 12, where the communication device is a wireless communication device, and the media-related data is sent via a short messaging service.

16. A computer-readable medium encoded with a computer program for providing media-related data to a communication device from a database storing media-related events associated with a geographical area, the computer program including computer program code to cause a processor of the database perform operations comprising:
receiving a request from the communication device for media-related data, the request identifying a geographical area determined by the communication device and a trigger to search the database for the requested media-related data associated with the received geographical area;
detecting the trigger and the requested media-related data;
searching the database for the requested media-related data;
reading the requested media-related data from the database; and
sending the requested media-related data to the communication device.

17. An arrangement to provide media-related data to a communication device from a database including media-related events associated with geographical areas, the arrangement comprising:
a receiving unit to receive a request from the communication device for media-related data associated with a particular geographical area identified by the communication device, the request including a trigger to search the database for the requested media-related data associated with the particular geographical area;
a detecting unit to detect the trigger and the requested media-related data;
a searching unit to search the database for the requested media-related data based on the detection of the trigger;
an extracting unit to extract the requested media-related data from the database; and
a providing unit to output the extracted media-related data to the communication device.
